(19) United States
(12) Patent Application Publication
(10) Pub. No.: US 2025/0037380 A1
(43) Pub. Date: Jan. 30, 2025

(54) ADAPTIVE IMMERSIVE VISUAL DISPLAY IN IMMERSIVE ENVIRONMENTS

(71) Applicant: THE WEATHER COMPANY, LLC, Brookhaven, GA (US)

(72) Inventors: Robert N. Redmond, Smyrna, GA (US); Scott McCall, Durham, NC (US); Brian Andrew Hull, Brooklyn, NY (US); ALICE MARIE GWIN, New York City, NY (US); Paul M. Matchen, Bethel, CT (US); Will Spann, Atlanta, GA (US)

(21) Appl. No.: 18/226,443

(22) Filed: Jul. 26, 2023

(51) Int. Cl. G06T 19/00; G06F 3/01; G06Q 30/0251

(52) U.S. Cl. CPC G06T 19/00; G06F 3/011; G06Q 30/0265

(57) ABSTRACT

A system, method, and computer program product are configured to: obtain information associated with a user's environment; generate potential spatial and display contexts by modeling possible variations and customizations within an immersive environment based on the information associated with a user's environment, wherein the immersive environment is being viewed by the user; generate, based on the potential spatial and display contexts, a customized immersive visual display; and present the immersive visual display within the immersive environment to provide an immersive visual display experience. The user's environment includes user actions, environmental factors, and surface context within the user's field of view.

### BACKGROUND

Aspects of the present invention relate generally to visual displays in immersive environments, and, more particularly, to methods and systems for delivering visual displays to a user of the immersive environment by adapting the visual displays to the user's actions, environmental factors, and surface contexts.

Today, advertising is a multi-billion dollar industry that provides brands with messaging platforms across a multitude of channels, such as digital, video, social, internet of things (iOT), over-the-top (OTT), connected television (CTV), and out of home (OOH) advertising. Increasingly brands and the advertising agencies that serve them are seeking to leverage new and novel ways to reach their consumers.

Over the past few years many brands have ventured into immersive environments (such as augmented reality (AR), virtual reality (VR), or extended reality (XR)) by experimenting on platforms like Snap-chat and Facebook with AR filters, or by providing individuals with the ability to virtually place a product within their environment. Currently, brands have largely been operating within environments that are driven by entertainment or interaction with another user.

### SUMMARY

In a first aspect of the invention, there is a computer-implemented method including: obtaining information associated with a user's environment, wherein the information includes: (i) user actions, (ii) environmental factors, and (iii) surface context within the user's field of view; generating potential spatial and display contexts by modeling possible variations and customizations within an immersive environment based on the information associated with a user's environment, wherein the immersive environment is being viewed by the user; generating, based on the potential spatial and display contexts, a customized immersive visual display; and presenting the display within the augmented reality environment to provide an immersive visual display experience.

In another aspect of the invention, there is a computer program product including one or more computer readable storage media having program instructions collectively stored on the one or more computer readable storage media. The program instructions are executable to: obtain information associated with a user's environment, wherein the information includes: (i) user actions, (ii) environmental factors, and (iii) surface context within the user's field of view; generate potential spatial and display contexts by modeling possible variations and customizations within an immersive environment based on the information associated with a user's environment, wherein the immersive environment is being viewed by the user; generate, based on the potential spatial and display contexts, a customized immersive visual display; and present the display within the augmented reality environment to provide an immersive visual display experience.

In another aspect of the invention, there is a system including a processor set, one or more computer readable storage media, and program instructions collectively stored on the one or more computer readable storage media. The program instructions are executable to: obtain information associated with a user's environment, wherein the information includes: (i) user actions, (ii) environmental factors, and (iii) surface context within the user's field of view; generate potential spatial and display contexts by modeling possible variations and customizations within an immersive environment based on the information associated with a user's environment, wherein the immersive environment is being viewed by the user; generate, based on the potential spatial and display contexts, a customized immersive visual display; and present the display within the augmented reality environment to provide an immersive visual display experience.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a diagram of an exemplary use of the modeling server to provide a customized visual display experience in an AR environment in accordance with aspects of the present invention.

FIG. 5 shows a flowchart of an exemplary method in accordance with aspects of the present invention.

### DETAILED DESCRIPTION

Aspects of the present invention relate generally to visual displays in immersive environments, and, more particularly, to methods and systems for delivering visual displays to a user of the immersive environment by adapting the visual displays to the user's actions, environmental factors, and surface contexts.

With the growing potential for mainstream, utilitarian experiences to drive wider day-to-day use of AR interfaces, these visual experiences need to run on a sophisticated engine that can do more than currently available AR experiences. For example, current immersive visual display experiences require users to select a flat surface to “project” onto or to map to the user's face and do not have the ability to adapt to current environmental conditions of the user (e.g., day or night, lighting level, and/or current weather), the context of their active experience (e.g., whether the user is walking, holding still, or talking to someone), or the viewing environment of the user (e.g., whether the viewing environment is inside or outside, public or private). It is desirable to adapt immersive visual displays to environmental conditions of the user to provide a powerful novel platform through which brands can engage with consumers and enrich consumer experiences. The visual display may comprise, e.g., an advertisement, an informational display, an announcement, or a broadcast.

Aspects of the present invention relate generally to visual displays in an immersive environment (such as augmented reality (AR), virtual reality (VR), and extended reality (XR) environments), and, more particularly, to methods and systems for delivering visual displays to a user by adapting the visual displays to the user's actions, environmental factors, and surface contexts. Unless otherwise indicated, XR, VR, and AR, as used herein, are not distinguished from each other, and are collectively referred to as immersive environment. According to aspects of the invention, information relating to a user's environment is collected and used to generate possible variations and customizations within the user's immersive environment for delivery of an visual display in the immersive environment. The possible variations and customizations are then evaluated, by machine-based decision making, with preset requirements from the originator to select one of the possible variations and customizations to display within the user's field of view in the user's immersive environment. The originator may be an individual or an organization who wants to provide information in the visual display. For example, the originator may be a business wishing to advertise its product in the visual display or an organization wishing to provide a public service announcement in the visual display. The aspects of the present invention allow for determination of the kind of visual to display in the user's immersive environment and the location of the visual display in the user's immersive environment. In embodiments, the visual display can adapt to features within the user's environment or to user's information. In this manner, implementations of the invention provide a powerful novel platform through which brands can engage with consumers and enrich consumer experiences.

Implementations of the invention provide a method, system, and computer program product for real-time adaptive immersive visual display within an augmented reality environment. In embodiments, the method, system, and computer program product are configured to: obtain contextual information associated with a user's augmented reality environment, wherein the contextual information includes: (i) user actions, (ii) environmental factors (e.g., weather conditions, future weather forecast, lighting, time of day, artificially adjusted conditions), and (iii) surface context within the user's field of view (e.g., polygons, vectors, space and depth of objects); model possible variations and customizations within the augmented reality environment based on the contextual information; generate, based on the modeled possible variations and customizations within the augmented reality environment, one or more potential spatial and display contexts for a customized immersive visual display experience; and present a 3-dimensional customized immersive visual display within the user's augmented reality field of view using at least one of the generated potential spatial and display contexts, wherein the 3-dimensional (3D) customized immersive visual display experience is modified as the contextual information associated with the user's immersive environment changes.

Implementations of the invention are necessarily rooted in computer technology. For example, the step of modeling possible variations and customizations within an augmented reality environment based on the information environment is computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example, personal information related to the user), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as modeling code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

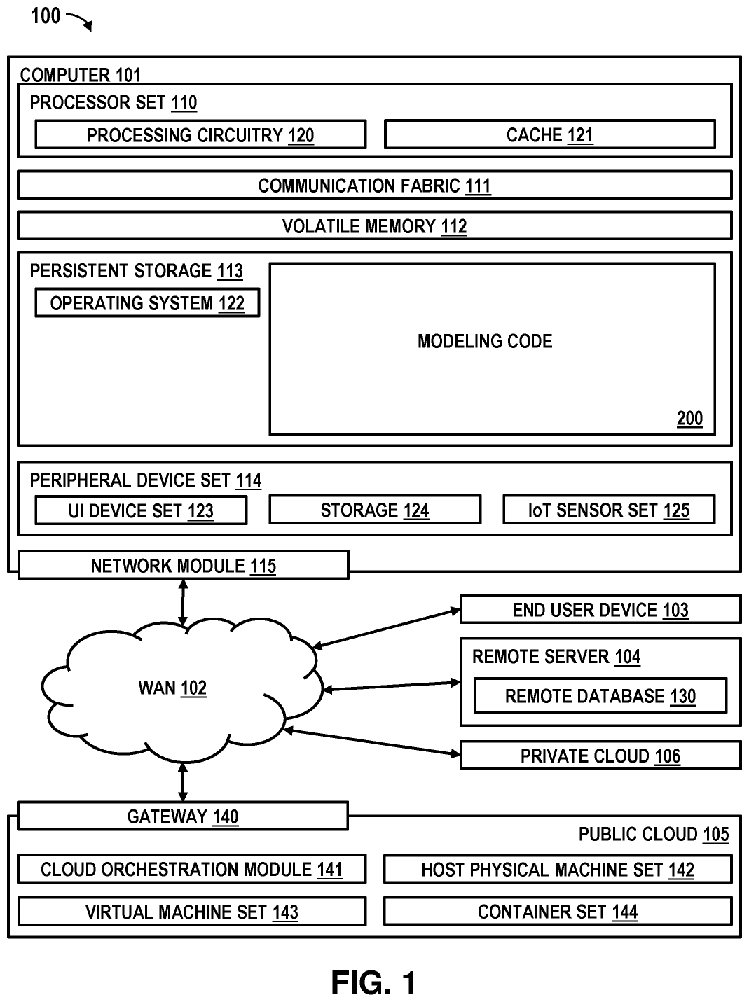

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

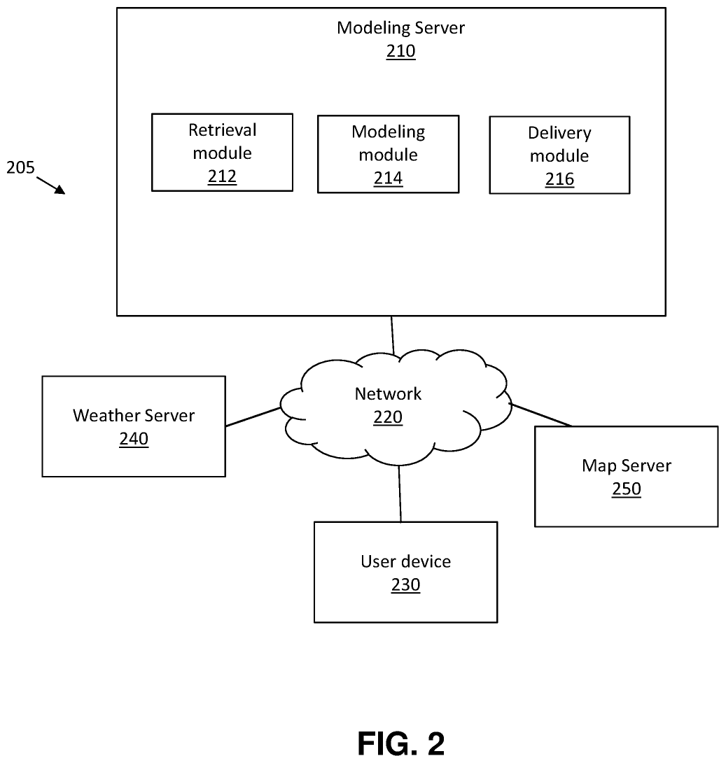

FIG. 2 shows a block diagram of an exemplary environment 205 in accordance with aspects of the invention. In embodiments, the environment 205 includes a user device 230, a weather server 240, a map server 250 and a modeling server 210. The user device 230, the weather server 240, the map server 250, and the modeling server 210 are in communication over a network 220. In an example, the modeling server 210 comprises one or more instances of the computer 101 of FIG. 1, or one or more virtual machines or one or more containers running on one or more instances of the computer 101 of FIG. 1. The user device 230 may comprise one or more instances of the EUD 103 of FIG. 1. The weather server 240 may comprise one or more instances of the remote server 104 of FIG. 1. The map server 250 may comprise one or more instances of the remote server 104 of FIG. 1. The network 220 may comprise one or more networks such as the WAN 102 of FIG. 1.

In embodiments, the user device 230 is a device used by a user to experience the immersive experience, such as AR, VR, or XR. The user device 230 may be, but is not limited to, a computer, a smartphone, a tablet, a headset (such as VR, AR, or XR headset), smart glasses, or combinations thereof. The user device 230 may include sensor(s) for collecting, measuring, or determining information associated with a user's environment. The sensor(s) may be, but are not limited to, LiDAR (light detection and ranging) scanner, camera, microphone, positioning system (e.g., GSP), surface detector, depth/distance sensor, elevation sensor, gyroscopic or motion detector, or combinations thereof. The sensor(s) may be used to determine location, lighting condition, depth/distance, speed, heading, and time.

In embodiments, the weather server 240 provides weather information and weather forecasting service. The weather server 240 may be used by the modeling server 210 to gather weather information and weather forecast information for the location of the user device 230, as described below.

In embodiments, the map server 250 provides mapping data. The map server 250 may be used by the modeling server 210 to gather mapping data in the area of the location of the user device 230, as described below.

In embodiments, the modeling server 210 receives the information associated with the user's environment from the user device 230 and/or the weather server 240 and provides a visual display to the user's field of view in an immersive environment based on the information associated with the user's environment. In embodiments, the user's personal information, such as age, location, intents, habits, behaviors, and topics of interest, and/or their classification within the originator domain, or combinations thereof, may also be used to inform the generation of the visual display. The visual display is selected and placed in the immersive environment based on the information associated with the user's environment.

In embodiments, the modeling server 210 comprises a retriever module 212, a modeling module 214, and a delivery module 216, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The modeling server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In embodiments, the retrieval module 212 retrieves information from the sensor(s) on the user device 230 and the weather server 240 and collects and/or determines information relating to the user's environment and the user's personal information. The user's personal information may include, but is not limited to, number of family members, income, interests, marital status, preferences (such as, food, websites visited, brand of automobile, etc.), and/or combinations thereof. The user's personal information may be obtained from the platform on which the user uses to access the immersive experience. For example, when the user registers to use the platform, a survey may be used to obtain the user's personal information during the registration process. A survey may also be presented to the user each time the user signs on to the platform. In embodiments, a user must opt-in before any of their personal information is obtained and used as described herein.

Information relating to the user's environment (environmental information) may be obtained directly from the sensors on the user device 230 or determined therefrom. The environmental information includes user actions, environmental condition factors, and surface contexts.

The user actions relate to information on what the user is doing. The user actions include, but are not limited to, movement of the user, interactions by the user, and combinations thereof, which may be determined, e.g., from the camera, positioning system, and/or LiDAR on the user's device 230. For example, the movement of the user may be determined by monitoring the camera; the speed and direction of the user's movement may be determined by, e.g., the GPS system, and the orientation of the device may be determined by, e.g., gyroscopic detection. The camera may also be used to detect interactions of the user with the objects in his/her environment.

The environmental condition factors relate to information on the conditions of the environment in the location of the user. The environmental factors include, but are not limited to, current weather, weather forecast, time, lighting condition, geographic location, indoor/outdoor location, public/private location, transit situation (e.g., public transit, automobile, etc.), artificially adjusted conditions (e.g., colored lighting, light shades, climate control, etc.), or combinations thereof, which may be determined, e.g., from the sensors on the user's device 230. For example, current weather and weather forecast may be determined from the weather server based on a location defined by the GPS. Here, the location of the GPS on the user's device 230 may be used to obtain the current weather condition and weather forecast for that location from the weather server 240. The location may also be used to determine whether the user is in public or in transit. For example, the location information is used to fetch map data from the map server 250 for that location; and the heading, elevation, speed, and map location may be used to determine whether the user is likely in a vehicle, on a train, in a plane, in a building or out in public. The time may be obtained directly from the clock on the user's device 230. The lighting condition may be obtained, e.g., from the camera on the user's device 230. LiDAR may be used to determine whether the user is indoors or outdoors by scanning and mapping the user's immersive environment.

In embodiments, the surface contexts relate to information on the surfaces, objects, and movements of objects within the user's immersive environment. The surface contexts include, but are not limited to, shapes of objects (polygons), vectors, space, and depth within the user's immersive environment, which may be determined from sensors on the user's device 230. For example, shapes and depths of objects from the user's device may be determined using LIDAR. Distances between the objects may be determined using the camera and/or LIDAR. Vectors indicating the movements of objects within the user's field of view may be determined, e.g., by LIDAR. In embodiments, LIDAR scanning maps the surfaces and objects in the physical space. Visual recognition may also be used to map objects and surfaces, and may identify target images such as product logos, QR codes, landmarks, etc. In embodiments, depth and distance may be determined by LIDAR, surface detection, and/or visual recognition sensor to determine if the user is inside or outside, surrounded by walls or the confines of a structure or vehicle. In embodiments, object detection uses LIDAR and visual recognition to identify target objects or images in the environment (e.g., a product package, a picture, a landmark, etc.).

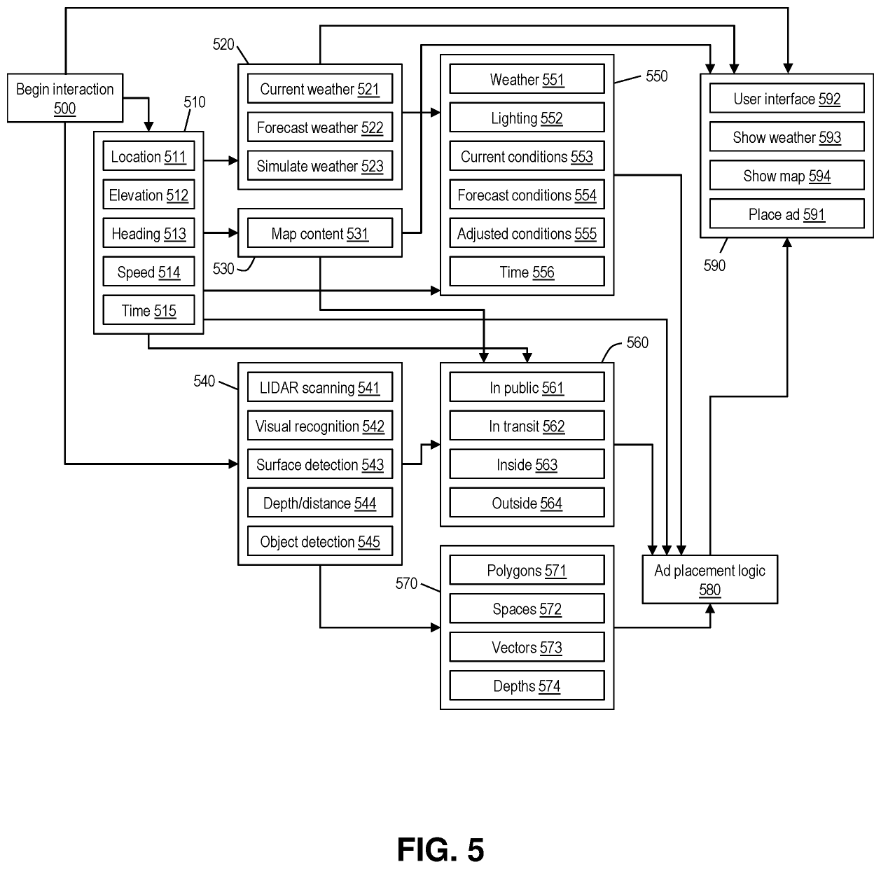

In embodiments, the modeling module 214 takes the information provided by the retrieval module 212 (information relating to the user's environment (environmental information), or environmental information and the user's personal information) to model possible variations and customizations within the user's immersive environment and generates a number of potential spatial and display contexts. The potential spatial and display contexts pertain to what to display and where to display the visual display within the user's immersive environment. In embodiments, the modeling module 214 uses machine learning and machine decision making to generate potential spatial and display contexts. An example of the decision making to generate potential spatial and display contexts is described herein with respect to FIG. 5.

In embodiments, the delivery module 216 uses potential spatial and display contexts and preset requirements by the originator to decide how and where within the user's field of view to place the visual display, thereby, providing a customized immersive visual display. The delivery module 216 the presents the customized immersive visual display within the immersive environment to provide a customized visual display experience for the user. The preset requirements are defined by the originator and are saved in system for use by the delivery module 216. The preset requirements (e.g., advertising assets) may be visuals (such as video clips or pictures, messages, slogans, etc.) and instructions on the context in which to use the visuals. The visuals represent potential visual displays that may be displayed in the user's immersive environment. The instructions provide preferences for how and when the visual may be displayed. The instruction may be hard logic (e.g., if a, then do b) or fuzzy logic (e.g., pick the best potential outcome based on available data). The instructions may be, but are not limited to, position within the immersive environment, time of day, whether conditions, and spatial context. As an exemplary instruction, the visual is instructed for display on glass as part of the user interface and is and is always present on the screen. In another exemplary instruction, the visual is instructed for display in space in the immersive environment where no objects or surfaces are detected (the size of space requested may be specified by the preferences). In a further exemplary instruction, the visual is placed virtually on or against a detected surface within the immersive environment. The instruction may also define the time of day to display the visual (e.g., only display the visual during certain hours or during daylight, dawn, dusk night, etc.). The instruction may also define the weather condition or weather forecast to display the visual (e.g., only during rain or snow or only when snow is forecasted). The instruction may also define the spatial context to display the visual (e.g., only when the user is outside or inside, only while walking or moving inside, only while in as vehicle/train/plane, or only while in a building).

In embodiments, the delivery module 216 evaluates the preset requirements and the potential spatial and display contexts, and uses machine-based decision making to determine which visual to use and where within the user's visual spectrum to place the visual for engagement while managing the relationship between the user interface and features of the immersive experience. The selected visual and the location within the user's immersive environment to place the visual constitute the customized immersive visual display. Given an inventory of visuals and their placement preferences in the preset requirements, the delivery module 216 attempts to pair the best visual with the available environmental information. Potential visuals can be eliminated from inclusion if their instructions do not match the available environmental information. If the list of potential visuals is not empty after exclusion for not matching the preset instructions, the remaining visuals can be selected from by a variety of criteria including, but limited to, priority (some visuals may be higher paying or have other preferential positioning and be selected above others), round robin (visuals may be selected based on when they were last used, so that a visual that has been used less frequently than other candidates may be used), bidding (potential candidate visuals may participate in bidding and the highest bidder gains placement), or random (a visual may be selected randomly from among the current candidates). The selected visual may be displayed in the immersive environment in two-dimensions (2D) or three-dimensions (3D).

In accordance with aspects of the invention, the retrieval module 212 retrieves data from information from the sensor(s) on the user device 230 and the weather server 240 and collects and/or determines environmental information and the user's personal information. Although specific environmental information and the user's personal information is described herein, it is not a comprehensive list. It is also understood that not all information is available at all times. The retrieval module 212, however, is configured to collect as much information as possible. The modeling module 214 uses the environmental information (or the environmental information and the user's personal information) to model possible variations and customization within the user's immersive environment and generates a number of potential spatial and display contexts to employ. The delivery module 216 evaluates the preset requirements by the originator and the potential spatial and display contexts to determine which visual display to use and where within the user's visual spectrum to place the visual display.

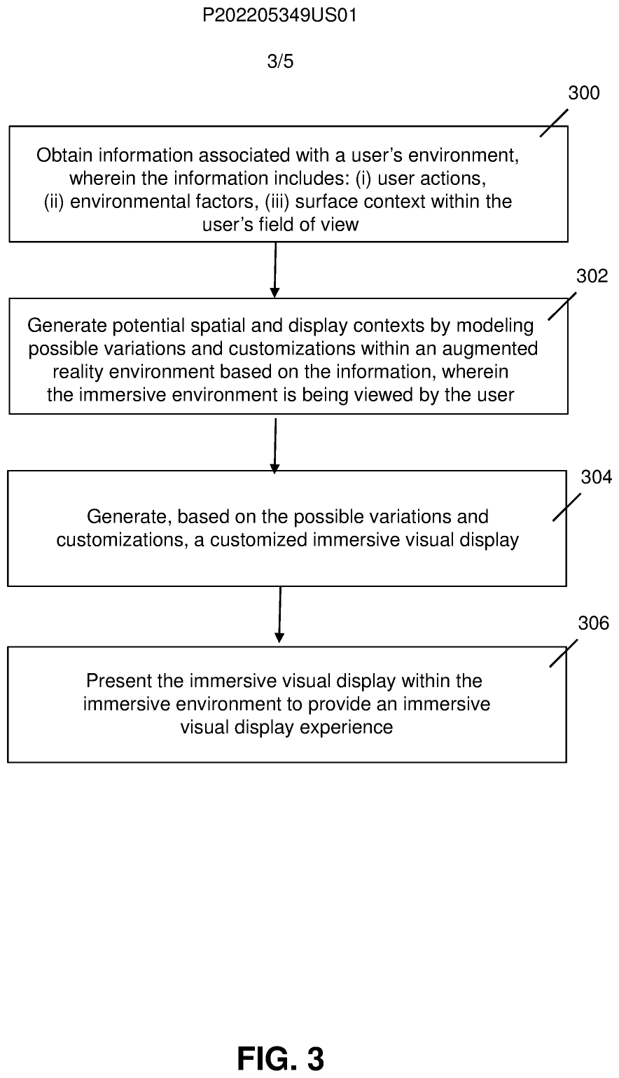

FIG. 3 shows a flowchart of an exemplary method in accordance with aspects of the present invention. Steps of the method may be carried out in the environment of FIG. 2 and are described with reference to elements depicted in FIG. 2.

At step 300, the retrieval module 212 obtains information associated with a user's environment, wherein the information includes: (i) user actions, (ii) environmental factors, (iii) surface context within the user's field of view. In embodiments, as described with respect to FIG. 2, the retrieval module 212 performs this step.

At step 302, the modeling module 214 models possible variations and customizations within the user's immersive environment based on the information provided by the retrieval module 212 and generates a number of potential spatial and display contexts. The immersive reality environment is being viewed by the user. In embodiments, as described with respect to FIG. 2, the modeling module 214 performs this step.

At step 304, the delivery module 216 generates, based on the potential spatial and display contexts, a customized immersive visual display. In embodiments, as described with respect to FIG. 2, the delivery module 216 performs this step.

At step 306, the delivery module 216 presents the customized immersive visual display within the immersive environment. In embodiments, as described with respect to FIG. 2, the delivery module 216 performs this step.

In embodiments, the methods and systems of aspects of the present application adapt the visual display to the user's actions, environmental factors, and surface contexts. For example, if weather includes rain, a car advertisement displayed in the user's immersive field of view includes the car being driven in the rain.

In embodiments, the process continuously updates the environmental information and adapts to features within the immersive experience or the changing environmental information. For example, if the lighting condition changes (e.g., getting darker) as the immersive experience progresses, the car advertisement displayed also gets darker with the lighting condition. Also, if the weather changes from rain to sunny, the weather depicted in the car advertisement also changes accordingly.

In embodiments, the user's immersive visual display experience is logged and saved, e.g., for analysis. Information logged may include, but is not limited to, user's interaction with the visual display, user's gaze time, user's dwell time, user's purchases, and combinations thereof. The log may be used by the originator to create/change its preset requirements or to train the modeling module 214 and/or delivery module 216.

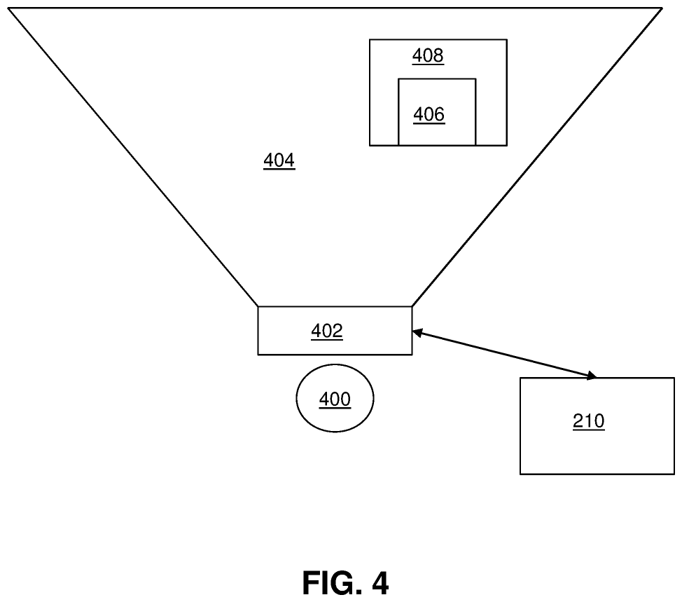

FIG. 4 is a diagram showing an exemplary use of the modeling server 210 in providing an immersive visual display experience for user 400 in accordance with aspects of the present invention. As shown in FIG. 4, the user 400 uses an AR device 402 to provide an AR environment having a field of view 404. The field of view 404 as seen through the AR device 402 is also referred to herein as the AR space or the AR environment. The AR device 402 may be, e.g., an AR headset. The modeling server 210, in communication with the LIDAR on the AR device 402, detects a surface 408 in the field of view 404. The modeling server 210 generates a visual display 406 in the AR device 402 such that the visual display 406 appears to the user 400 to be displayed in 3D on the surface 408.

The following examples illustrate the use of aspects of the present invention to deliver a visual display comprising advertisements to the user. Three potential advertisements are available: 1) a soup product with instruction for display in cold weather, at night, inside or outside on the glass of the user interface or table surface; 2) an insurance product with instruction for display in inclement weather, inside on the glass of the user interface or a surface; and 3) an automobile advertisement with instruction for display in sunny weather, during the day, inside on the glass of the user interface. In one example, the modeling server 210 determines that user A is walking outside in a cold rain, and displays the soup advertisement on the glass of the user interface because all preset instructions for the soup advertisement are met. The insurance and automobile advertisements are not displayed for user A because their preset instruction do not match the user's environmental information. In another example, the modeling server 210 determines that user B is sitting at a desk in an office on a warm cloudy day, and displays the automobile advertisement on the desk surface. The soup and insurance advertisements are not displayed for user B because their preset instructions do not match the user's environmental information. In a further example, the modeling server 210 determines that user C is on a train during a thunderstorm in the summer, and displays the insurance advertisement on the glass of the user interface. The soup and automobile advertisements are not displayed for user C because their preset instructions do not match the user's environmental information.

FIG. 5 shows a flowchart of an exemplary method in accordance with aspects of the present invention to deliver a visual display comprising an advertisement. The exemplary method of FIG. 5 provide a non-limiting example and do not limit the invention to advertisements. The visual display may comprise materials other than advertisements. Steps of the method, as shown in FIG. 5, may be carried out in the environment of FIG. 2 and are described with reference to elements depicted in FIG. 2.

Exemplary implementations of the invention provide a system and method for deploying adaptive immersive visual display experiences within an AR platform wherein advertisers would seek to drive contextually and environmentally relevant messages to their audiences. An exemplary flowchart of such a method is shown in FIG. 5. Exemplary implementations of the method, as shown in FIG. 5, may include a first phase in which an interaction begins, a second phase in which a visualization is prepared, and a third phase in which the prepared visualization is delivered to the user via their AR device (e.g., user device 230 of FIG. 2 or AR device 402 of FIG. 4).

In embodiments, during the first phase (e.g., interaction begins), a user begins to interact with the AR platform via their AR device (e.g., user device 230 of FIG. 2 or AR device 402 of FIG. 4). In response to this, the adaptive immersive visual display system (e.g., modeling server 210 of FIG. 2) gathers immersive contexts by employing several visual and spatial computing techniques including but not limited to LIDAR scanning, visual recognition, surface, depth, and object detection. This information gathering may be performed by the retrieval module 212 of the modeling server 210 of FIG. 2 as described herein. In embodiments, the retrieval module 212 organizes this gathered information into a number of distinct buckets (e.g., categories) of information. In one example, there are four buckets including: user context (e.g., is the user moving, is the user stationary, is the user having a conversation, etc.); environmental context (e.g., is the user indoors or outdoors, is the user in a private setting or a public setting, is the user in transit such as driving, etc.); conditional context (e.g., current weather at the user location, forecast future weather at the user location, lighting at the user location, time of day, artificially adjusted conditions, etc.); and surface context (e.g., polygons, vectors, space, depth or surfaces in the user field of view). In addition to this information, the retrieval module 212 may additionally gather information related to the user within the advertiser's audience and advertisement-targeting rules (e.g., cohorts the user is included in, whether the user is known or unknown to the advertiser, etc.).

In embodiments, during the second phase (e.g., visualization preparation), the adaptive immersive visual display system models the possible variations and customization within the user's current immersive contexts and generates a number of potential spatial and display contexts for the advertising experience to employ. This may be performed by the modeling module 214 of the modeling server 210 of FIG. 2 as described herein. In embodiments, the advertiser's creative team has generated messages and visuals on top of the adaptive immersive advertising framework. In embodiments, this advertising unit is awaiting inputs calculated by the models derived from immersive contexts. In exemplary embodiments, this adaptive advertising framework allows advertisers to provide both hard logic (e.g., predefined rules based on one or more conditions being satisfied) and fuzz logic (e.g., select the best potential outcome based on the available data).

In embodiments, during the third phase (e.g., visualization delivery), the adaptive immersive visual display system evaluates preset requirements defined by the advertiser and then uses machine based decisioning to determine how and where within the user's visual spectrum (e.g., field of view 404 of FIG. 4) the adaptive immersive advertising unit will be placed for engagement while managing the relationship between the AR experiences UI and features. This may be performed by the delivery module 216 of the modeling server 210 of FIG. 2 as described herein. In embodiments, the delivery module 216 adapts the displayed advertisement to features (e.g., surfaces) within the user's AR experience, or to immersive context, based on the profile and logic defined in the advertising unit. In embodiments, the delivery module 216 logs the immersive context along with interaction types taken by the user, thus generating an adaptive immersive experience engagement report that can be used for future refinements and/or visualization preparation and delivery.

In FIG. 5, block 500 represents a user beginning an interaction with the AR platform via their AR device (e.g., user device 230 of FIG. 2 or AR device 402 of FIG. 4), e.g., as described above in the first phase. In embodiments, in response to the user beginning the interaction, the retrieval module 212 obtains user context information represented at block 510 and including the user's current location 511, the user's current elevation (e.g., altitude) 512, the user's current heading (e.g., compass direction) 513, the user's current speed (e.g., of movement) 514, and the and local time 515 of the user's location. This information may be obtained from the user device (e.g., user device 230 of FIG. 2 or AR device 402 of FIG. 4). In embodiments, the retrieval module 212 uses the location 511 to obtain weather information represented at block 520 and including current weather 521 at the user's location, forecast weather 522 at the user's location, and simulated weather 523 at the user's location. This information may be obtained from the weather server 240 of FIG. 2. In embodiments, the retrieval module 212 uses the location 511 to obtain map information represented at block 530 and including map content 531. This information may be obtained from the map server 250 of FIG. 2. In embodiments, the retrieval module 212 uses the heading 513, elevation 512, speed 514, and map content 531 to determine whether the user is in an automobile, on a train, in an airplane, in a building, or in an open space.

With continued reference to FIG. 5, block 540 represents the retrieval module 212 obtaining current physical environment data from the user device. In embodiments, the user device uses various sensors to scan the current physical environment (e.g., within the user's field of view) to obtain data based on LIDAR scanning 541, visual recognition 542, surface detection 543, depth/distance 544 data, and object detection 545, and the retrieval module 212 obtains this information from the user device. For example, the LIDAR scanning maps the surfaces and objects in the current physical environment. In another example, the visual recognition 542 also maps objects and surfaces in the current physical environment, and may identify target images such as product logos, QR codes, landmarks, etc. In another example, the surface detection 543 uses the LIDAR scanning 541 and the visual recognition 542 to identify horizontal, vertical, and slanted surfaces within the current physical environment, along with size, elevation, and distance from user for each surface. In another example, the depth/distance 544 is determined using the LIDAR scanning 541 and the visual recognition 542 to determine if the user is inside or outside, surrounded by walls, or in the confines of a structure or vehicle. In another example, the object detection 545 uses the LIDAR scanning 541 and the visual recognition 542 to identify target objects or images in the environment (e.g., a product package, a picture, a landmark, etc.).

With continued reference to FIG. 5, block 550 represents the retrieval module 212 determining the conditional context information, which may include physical conditions the user is or may be subject to, such as current weather 551, current lighting 552, current conditions 553, forecast conditions 554, adjusted conditions 555, and time of day 556. In embodiments, the retrieval module 212 determines the conditional context information at block 550 based on the user context information represented of block 510 and the weather information of block 520.

With continued reference to FIG. 5, block 560 represents the retrieval module 212 determining the environmental context information, which may include the user's physical location, speed, and elevation. For example, the retrieval module 212 uses the user context information represented of block 510 and the current physical environment data of block 540 to determine whether the user is in public 561, in transit 562, inside 563, outside 564, etc.

With continued reference to FIG. 5, block 570 represents the retrieval module 212 determining the surface context information, which may include the geometry of the user's current physical environment (e.g., within the user's field of view) and an identification of the surfaces and placement of objects in the user's current physical environment. For example, the retrieval module 212 uses the current physical environment data of block 540 to determine polygons 571, spaces 572, vectors 573, and depths 574 in the user's current physical environment.

With continued reference to FIG. 5, in accordance with aspects of the invention, the user context information of block 510, the conditional context information of block 550, the environmental context information of block 560, and the surface context information of block 570 are fed to the advertisement placement logic represented by block 580. In embodiments, the advertisement placement logic is programmed in the modeling module 214 of FIG. 2, and the retrieval module 212 provides this information to the modeling module 214.

With continued reference to FIG. 5, in accordance with aspects of the invention, the advertisement placement logic of block 580 uses the user context information of block 510, the conditional context information of block 550, the environmental context information of block 560, and the surface context information of block 570, along with an inventory of potential advertisements, to determine the best choice for an advertisement and a placement of the advertisement in the field of view of the user device (e.g., field of view 404 of FIG. 4). In embodiments, the inventory of potential advertisements includes preferences for how and when each particular one of the advertisements may be displayed. The preferences may include but are not limited to: positioning within the AR space; time of day; weather conditions; and spatial context. Preferences defined for positioning within the AR space may include but are not limited to: on the glass (e.g., the advertisement is displayed as part of the user interface of the user device and is always present on the screen of the user device); in space (e.g., the advertisement is placed in a virtual location within the AR environment where no objects or surfaces are detected, where the size of space requested may be specified by the advertisement preferences); on a surface (e.g., the advertisement is placed virtually on or against a detected surface within the AR space, where the size and orientation of the surfaces requested may be specified by the advertisement preferences. Preferences defined for time of day may include, but are not limited to, displaying the advertisement during certain hours; and displaying the advertisement during daylight, dawn, dusk, night, etc. Preferences defined for weather conditions may include, but are not limited to, displaying the advertisement during certain current weather conditions, and displaying the advertisement during certain forecast weather conditions. Preferences defined for spatial context may include, but are not limited to, displaying the advertisement while the user is standing still outside; displaying the advertisement while the user is standing still inside; displaying the advertisement while the user is walking or moving outside; displaying the advertisement while the user is walking or moving inside; displaying the advertisement while the user in one of a vehicle, plane, and train; and displaying the advertisement while the user is in a building.

With continued reference to FIG. 5, in accordance with aspects of the invention, the advertisement placement logic of block 580 is programmed to determine the best advertisement, from the potential advertisements in the inventory, for displaying on the user device 230. In embodiments, this determining is made based on a combination of: (i) the obtained context information (e.g., the user context information of block 510, the conditional context information of block 550, the environmental context information of block 560, and the surface context information of block 570), and (ii) the respective preferences of all of the potential advertisements. In embodiments, the advertisement placement logic of block 580 makes this determination by first eliminating all potential advertisements with one or more preferences that do not match the obtained context information. After eliminating ones of the potential advertisements in the inventory based on preferences not matching the obtained context information, the advertisement placement logic of block 580 then selects one of the remaining advertisements from the inventory of potential advertisements based on one or more selection criteria including: priority (e.g., some advertisements in the inventory of potential advertisements may be higher paying or have other preferential positioning and thus be selected over others); round robin (e.g., advertisements may be selected based on when they were last served to a user, such that an advertisement that has been served less frequently may be selected over others); bidding (e.g., potential candidate advertisements may participate in a bidding and the highest bidder is selected over the others); and random (e.g., an advertisement may be selected randomly from the remaining potential advertisements).

With continued reference to FIG. 5, in accordance with aspects of the invention, block 590 represents the display of the user device (e.g., user device 230 of FIG. 2 or AR device 402 of FIG. 4). In embodiments, based on the advertisement placement logic 580 selecting an advertisement, the delivery module 216 causes the user device to display the selected advertisement in a particular manner in the AR space of the user's field of view. This may include sending signals to the user device 230 that cause the user device to place the advertisement 591 in a user interface 592. In embodiments, the advertisement 591 is displayed relative to a surface in the AR space as described herein. The displaying the advertisement in the user device may optionally include showing weather information in the AR space (as indicated at show weather 593) and/or showing map information in the AR space (as indicated at show map 594).

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of the visual display(s) to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising of:
obtaining, by a processor set, information associated with a user's environment, wherein the information includes: (i) user actions, (ii) environmental factors, and (iii) surface context within the user's field of view;
generating, by the processor set, potential spatial and display contexts by modeling possible variations and customizations within an immersive environment based on the information associated with a user's environment, wherein the immersive environment is being viewed by the user;
generating, by the processor set and based on the potential spatial and display contexts, a customized immersive visual display; and
presenting, by the processor set, the immersive visual display within the immersive environment to provide an immersive visual display experience.

2. The computer-implemented method of claim 1, wherein the environmental factors comprise one or more selected from the group consisting of weather conditions, location, future weather forecast, lighting, time of day, and artificially adjusted conditions.

3. The computer-implemented method of claim 1, wherein the surface contexts comprise one or more selected from the group consisting of polygons, vectors, space, and depth of objects.

4. The computer-implemented method of claim 1, further comprising modifying the immersive visual display as the information associated with the user's environmental changes.

5. The computer-implemented method of claim 1, further comprising obtaining information related to the user, and using the information related to the user and the information associated with the user's environment in generating the customized immersive visual display.

6. The computer-implemented method of claim 1, wherein the information associated with the user's environment is obtained from one or more selected from the group consisting of LIDAR, a camera, and a microphone.

7. The computer-implemented method of claim 1, wherein the generating a customized immersive visual display comprises selecting one of the one or more potential spatial and display contexts based on preset requirements.

8. The computer-implemented method of claim 1, further comprising logging the immersive visual display experience.

9. The computer-implemented method of claim 8, wherein the logging comprises recording one or more selected from the group consisting of user's gaze time, dwell time, user's interaction with the immersive visual display, and user's purchasing based on the immersive visual display.

10. The computer-implemented method of claim 1, wherein the immersive environment is displayed on one or more selected from the group consisting of a computer, a smartphone, a tablet, a headset, and smart glasses.

11. A computer program product comprising one or more computer readable storage media having program instructions collectively stored on the one or more computer readable storage media, the program instructions executable to:
obtain information associated with a user's environment, wherein the information includes: (i) user actions, (ii) environmental factors, and (iii) surface context within the user's field of view;
generate potential spatial and display contexts by modeling possible variations and customizations within an immersive environment based on the information associated with a user's environment, wherein the immersive environment is being viewed by the user;
generate, based on the potential spatial and display contexts, a customized immersive visual display; and
present the immersive visual display within the immersive environment to provide an immersive visual display experience.

12. The computer program product of claim 11, wherein the program instructions are executable to further modify the immersive visual display as the information associated with the user's environmental changes.

13. The computer program product of claim 11, wherein the program instructions are executable to further obtain information related to the user and using the information related to the user and the information associated with the user's environment in generating the customized immersive visual display.

14. The computer program product of claim 11, wherein the program instructions are executable to further log the immersive visual display experience.

15. The computer program product of claim 14, wherein the logging records one or more selected from the group consisting of user's gaze time, dwell time, user's interaction with the customized immersive visual display, and user's purchasing based on the customized immersive visual display.

16. The computer program product of claim 11, wherein the environmental factors comprise one or more selected from the group consisting of weather conditions, future weather forecast, location, lighting, time of day, and artificially adjusted conditions.

17. The computer program product of claim 11, wherein the surface contexts comprise one or more selected from the group consisting of polygons, vectors, space, and depth of objects.

18. A system comprising a processor set, one or more computer readable storage media, and program instructions collectively stored on the one or more computer readable storage media, the program instructions executable to:
obtain information associated with a user's environment, wherein the information includes: (i) user actions, (ii) environmental factors, and (iii) surface context within the user's field of view;
generate potential spatial and display contexts by modeling possible variations and customizations within an immersive environment based on the information associated with a user's environment, wherein the immersive environment is being viewed by the user;
generate, based on the potential spatial and display contexts, a customized immersive visual display; and
present the immersive visual display within the immersive environment to provide an immersive visual display experience.

19. The system of claim 18, wherein the program instructions are executable to further modify the immersive visual display as the information associated with the user's environmental changes.

20. The system of claim 18, wherein the program instructions are executable to further obtain information related to the user and using the information related to the user and the information associated with the user's environment in generating the customized immersive visual display.
